(19) United States
(12) Patent Application Publication
(10) Pub. No.: US 2022/0237196 A1
(43) Pub. Date: Jul. 28, 2022

(54) DATA MONITORING METHOD AND APPARATUS FOR STANDARDIZED MANAGEMENT SYSTEM, COMPUTER DEVICE, AND COMPUTER-READABLE STORAGE MEDIUM

(71) Applicant: CHANGXIN MEMORY TECHNOLOGIES, INC., Hefei City (CN)

(72) Inventors: Wenjie WANG, Hefei (CN); Dandan CHEN, Hefei (CN); SHENG-HUA SU, Hefei (CN); HUNG-CHIH KUO, Hefei (CN)

(73) Assignee: CHANGXIN MEMORY TECHNOLOGIES, INC., Hefei City (CN)

(21) Appl. No.: 17/447,187

(22) Filed: Sep. 8, 2021

Related U.S. Application Data
(63) Continuation of application No. PCT/CN2021/103916, filed on Jul. 1, 2021.

(30) Foreign Application Priority Data
Jan. 28, 2021 (CN) 202110134070.6

(51) Int. Cl. G06F 16/2457; G06F 16/248; G06F 16/2455; G06F 16/22; G06F 16/23

(52) U.S. Cl. CPC G06F 16/24573; G06F 16/248; G06F 16/2358; G06F 16/221; G06F 16/24564

(57) ABSTRACT

A data monitoring method for a standardized management system includes: obtaining log files of a standardized management system; parsing the log files to obtain parsed data, and saving the parsed data in a database; and displaying queried target data and historical data corresponding to the target data on a same interface according to a preset rule and the database.

### CROSS-REFERENCE TO RELATED APPLICATIONS

This is a continuation of International Patent Application No. PCT/CN2021/103916 filed on Jul. 1, 2021, which claims priority to Chinese Patent Application No. 202110134070.6 filed on Jan. 28, 2021. The disclosures of these applications are hereby incorporated by reference in their entirety.

### BACKGROUND

With the rapid development of technologies and the continuous improvement of the level of automation, a Manufacturing Execution System (MES) and a Material Management system (MM) serve as an important connecting link in an automatic production process. The MES and MM receive basic parameters or rules from a SM, and automatically operate according to data or rules set in the SM.

### SUMMARY

This application relates to a data monitoring method and apparatus for a Standardized Management system (SM), a computer device, and a computer-readable storage medium.

According to various embodiments, a first aspect of this application provides a data monitoring method for a SM, including:

obtaining log files of a SM;

parsing the log files to obtain parsed data, and saving the parsed data in a database; and

displaying queried target data and historical data corresponding to the target data on a same interface according to a preset rule and the database.

According to multiple embodiments, a second aspect of this application provides a data monitoring apparatus for a SM system, including a log file obtaining module, a parsed data obtaining module, and a monitoring display module. The log file obtaining module is configured to obtain log files of a SM system. The parsed data obtaining module is configured to parse the log files to obtain parsed data, and save the parsed data in a database. The monitoring display module is configured to display queried target data and historical data corresponding to the target data on a same interface according to a preset rule and the database.

A third aspect of this application provides a computer device, including a memory and a processor. The memory stores a computer program which can be run on the processor, and steps of the method in any embodiment in this application are implemented when the processor executes the program.

A fourth aspect of this application provides a non-transitory computer-readable storage medium with a computer program stored thereon. Steps of the method in any embodiment in this application are implemented when the computer program is executed by a processor.

The details of one or more embodiments of this application are provided in the following drawings and descriptions. Other features and advantages of this application will become apparent from the description, drawings and claims.

### BRIEF DESCRIPTION OF THE DRAWINGS

To describe the technical solutions in embodiments of this application more clearly, the accompanying drawings required for describing the embodiments are briefly introduced below. Apparently, the accompanying drawings in the following description show merely some embodiments of this application, and those skilled in the art can still derive accompanying drawings for other embodiments from these accompanying drawings without an inventive effort.

FIG. 1 is a schematic diagram of an application scenario of a data monitoring method for a SM provided in a first embodiment of this application.

FIG. 2 is a schematic flowchart of a data monitoring method for a SM provided in a second embodiment of this application.

FIG. 3 is a schematic flowchart of a data monitoring method for a SM provided in a third embodiment of this application.

FIG. 4 is a schematic flowchart of a data monitoring method for a SM provided in a fourth embodiment of this application.

FIG. 5 is a schematic flowchart of a data monitoring method for a SM provided in a fifth embodiment of this application.

FIG. 6 is a schematic flowchart of a data monitoring method for a SM provided in a sixth embodiment of this application.

FIG. 7 is a schematic flowchart of a data monitoring method for a SM provided in a seventh embodiment of this application.

FIG. 8 is a schematic flowchart of a data monitoring method for a SM provided in an eighth embodiment of this application.

FIG. 9 is a schematic flowchart of a data monitoring method for a SM provided in a ninth embodiment of this application.

FIG. 10 is a schematic flowchart of a data monitoring method for a SM provided in a tenth embodiment of this application.

FIG. 11 is a schematic flowchart of a data monitoring method for a SM provided in an eleventh embodiment of this application.

FIG. 12 is a structural block diagram of a data monitoring apparatus for a SM provided in a twelfth embodiment of this application.

FIG. 13 is a structural block diagram of a data monitoring apparatus for a SM provided in a thirteenth embodiment of this application.

FIG. 14 is a schematic structural diagram of a computer device provided in a fourteenth embodiment of this application.

### DETAILED DESCRIPTION

In order to facilitate understanding of this application, the following will make a more comprehensive description of this application with reference to relevant drawings. The drawings show preferred embodiments of this application. However, this application can be implemented in many different forms, which are not limited to the embodiments described herein. On the contrary, the purpose of providing these embodiments is to make understanding of the disclosure of this application more thorough and comprehensive.

Unless otherwise defined, all technical and scientific terms used herein have the same meaning as commonly understood by those skilled in the art to which this application pertains. Herein, the terms used in the description of this application are for the purpose of describing particular embodiments only and are not intended to be limiting of this application. As used herein, the term “and/or” includes any and all combinations of one or more of the associated listed items.

In a case where the terms “comprising”, “having”, and “including” described herein are used, unless a clear qualifier such as “only” and “consisting of” is used, another component can be added. Unless mention is made to the contrary, a singular term can include its plural form, and cannot be understood as one in number.

It should be understood that although terms “first”, “second”, etc. may be used herein to describe various elements, these elements should not be limited by these terms. These terms are only used to distinguish one element from another element. For example, without departing from the scope of this application, a first element may be referred to as a second element, and similarly, a second element may be referred to as a first element.

In order to better monitor the efficiency and reliability of automatic operation of the MES or MM, it may be necessary to actively collect and monitor production data in real time to manage production processes, ensure production quality, and effectively guide production operation of factories.

Specifically, a conventional SM includes huge data and has diverse data structures, it is not convenient for users to view, and does not have the function of providing historical data to ordinary users. Due to the lack of historical data in the SM, a manufacturing process personnel cannot compare and analyze parameter setting data of product manufacturing processes in different time intervals according to data in the SM, or timely discover an abnormality or failure in a production process. Moreover, if there is a human error when setting data in the SM, resulting in a data modification error or loss, it is difficult to quickly restore the original data and causing an unnecessary loss.

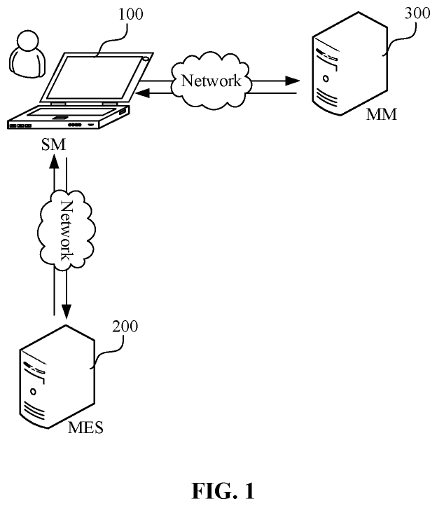

With reference to FIG. 1, in a semiconductor manufacturing and production process, a relevant worker sets process rules of the manufacturing process by a SM 100, and sets basic parameters of an MES 200 or an MM 300 interconnected to the SM by the SM, so that the MES and MM automatically operate according to parameter data and rules set in the SM. However, at present, a SM can only record and query real-time set data used by an MM. If data is modified, a user cannot obtain previous historical data of the current data, and cannot record or query an operation such as modification or deletion of the data. Moreover, the SM data is huge and the data structure is diverse. A user cannot view required target data and previous historical data on a same screen. Therefore, taking a semiconductor manufacturing and production process as an example, in order to make it convenient for a user to obtain historical data in a production management system, compare current data with historical data, discover a data abnormality or production abnormality timely, and improve the efficiency and reliability of automatic operation, this application provides a data monitoring method and apparatus for a SM, a computer device, and a computer-readable storage medium described in the following embodiments.

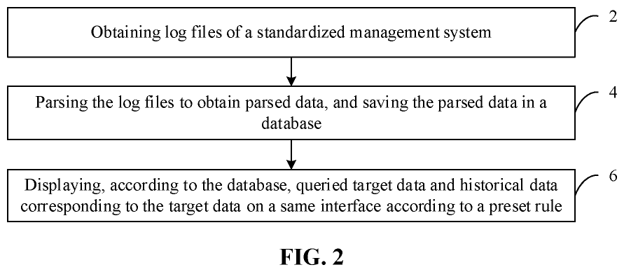

With reference to FIG. 2, provided in an embodiment of this application is a data monitoring method for a SM, including the following operations.

At S2, log files of a SM are obtained.

At S4, the log files are parsed to obtain parsed data, and the parsed data is saved in a database.

At S6, according to the database, queried target data and historical data corresponding to the target data are displayed on a same interface according to a preset rule.

Specifically, with continuing reference to FIG. 2, by obtaining log files of a SM, parsing the log files to obtain parsed data, saving the parsed data in a database, and displaying, according to the database, queried target data and historical data corresponding to the target data on a same interface according to a preset rule, it is convenient for a user to compare the target data and the historical data corresponding to the target data in the same interface, and discover a data change timely and restore the data, thereby preventing the user from changing saved data due to misoperation. It is also convenient for the user to analyze the historical data to discover production abnormality information or failure information timely, and take a countermeasure timely, so as to avoid an unnecessary loss.

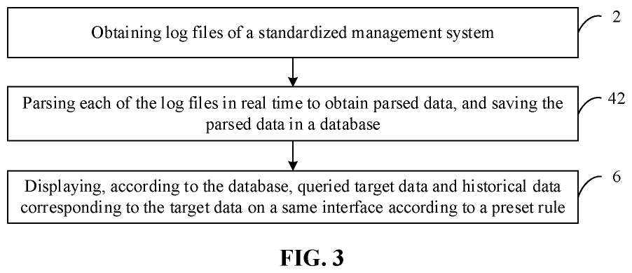

Further, with reference to FIG. 3, in an embodiment of this application, the parsing the log files to obtain parsed data includes the following operation.

At S42, each of the log files is parsed in real time to obtain the parsed data, and the parsed data is saved in the database.

Specifically, with continuing reference to FIG. 3, in an automatic production process, a large amount of real-time data will be generated in each production link, and a monitoring device in each generation link will also obtain various preset types of real-time monitoring data, so that a monitoring center can observe and analyze real-time operation in each production link through the real-time monitoring data. In order to comprehensively monitor data in the SM, each of the obtained log files of the SM is parsed in real time to obtain the parsed data, and the parsed data is saved in the database, so that target data and historical data corresponding to the target data are obtained according to the parsed data, so as to avoid a monitoring vulnerability. Moreover, it is convenient for a user to compare the target data and the historical data corresponding to the target data in a same interface, discover a data change timely and restore the data, so as to avoid an unnecessary loss caused by the user changing saved data due to misoperation.

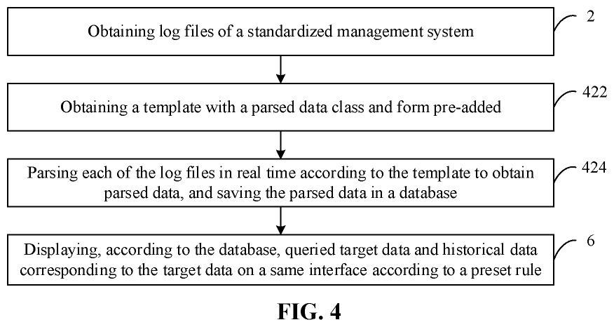

Further, with reference to FIG. 4, in an embodiment of this application, the parsing each of the log files in real time includes the following operations.

At S422, a template with a parsed data class and form pre-added is obtained.

At S424, each of the log files is parsed in real time according to the template to obtain the parsed data, and the parsed data is saved in the database.

Specifically, with continuing reference to FIG. 4, in order to improve the efficiency of parsing each of the obtained log files of the SM in real time, a template method can be used for parsing each of the log files in real time. For example, template form data required for reading data classes can be added in a real-time monitoring program (Watch Dog) in the SM, and the monitoring program automatically classifies and parses log files encountered to obtain parsed data, and saves the parsed data to a database. There can be a large amount of redundant and useless data in a log file. By the template method, the monitoring program can automatically recognize whether data in the log file satisfies a reading requirement through a special field set in a template, thereby effectively improving the efficiency of parsing the data in the log file in real time.

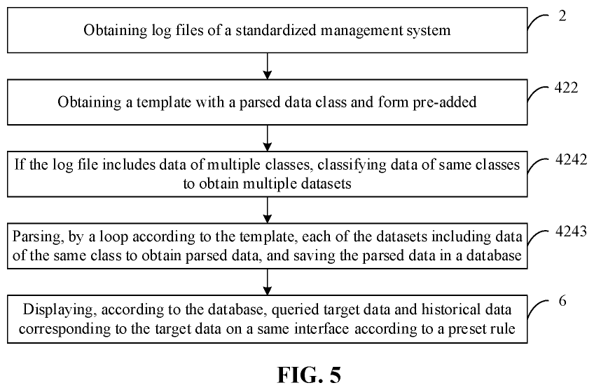

Further, with reference to FIG. 5, in an embodiment of this application, the parsing each of the log files in real time according to the template includes the following operations.

At S4242, if the log file includes data of multiple classes, data of same classes is classified to obtain multiple datasets.

At S4243, each of the datasets including data of the same class is parsed by a loop according to the template to obtain the parsed data, and the parsed data is saved in the database.

Specifically, with continuing reference to FIG. 5, in order to improve the efficiency of parsing each of the obtained log files of the SM in real time, a template method can be used for parsing each of the log files in real time. When processing a large amount of data of a same type, a monitoring program processes the data of the same type in a centralized manner by an aggregation method. For example, a template with a special field set in advance can be obtained. If a monitoring program identifies data corresponding to the special field from the log file, the monitoring program classifies the data as a set. Each piece of data in the set is classified as a set member. The data in the set is parsed and read by a loop in a centralized manner to obtain parsed data, and the parsed data is saved in a database. Thus, the efficiency of parsing data in a log file in real time can be effectively improved, the complexity of a data parsing program can be reduced, and the efficiency of program operation can be improved.

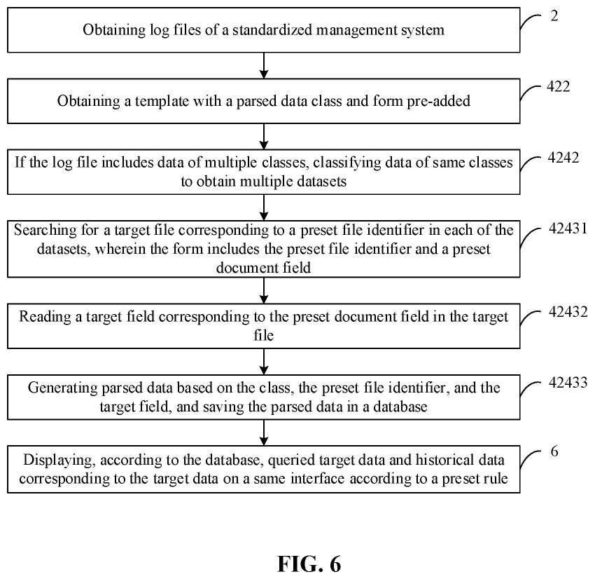

Further, with reference to FIG. 6, in an embodiment of this application, the parsing each of the datasets including data of the same class by a loop according to the template includes the following operations.

At S42431, a target file corresponding to a preset file identifier in the dataset is searched for. The form includes the preset file identifier and a preset document field.

At S42432, a target field corresponding to a preset document field in the target file is read.

At S42433, parsed data is generated based on the class, the preset file identifier, and the target field, and the parsed data is saved in the database.

Specifically, with continuing reference to FIG. 6, a form in a template can be set to include a preset file identifier and a preset document field. The preset file identifier can be used to indicate a file name, and the preset document field can be used as a search keyword, to perform matching search on content in a target file corresponding to the preset file identifier in a dataset. For example, a target file corresponding to a preset file identifier in an obtained dataset can be searched for, and a target field corresponding to a preset document field in the target file is read, so as to generate parsed data based on a parsed data class, the preset file identifier, and the target field, and save the parsed data in a database. For example, the class is set to folder AAA, the preset file identifier is set to CCC, and the target field is set to XXXX, to query an XXXX field in a file with a file name including CCC in a folder with a folder name including AAA, generate parsed data according to the query result, and save the parsed data in a database.

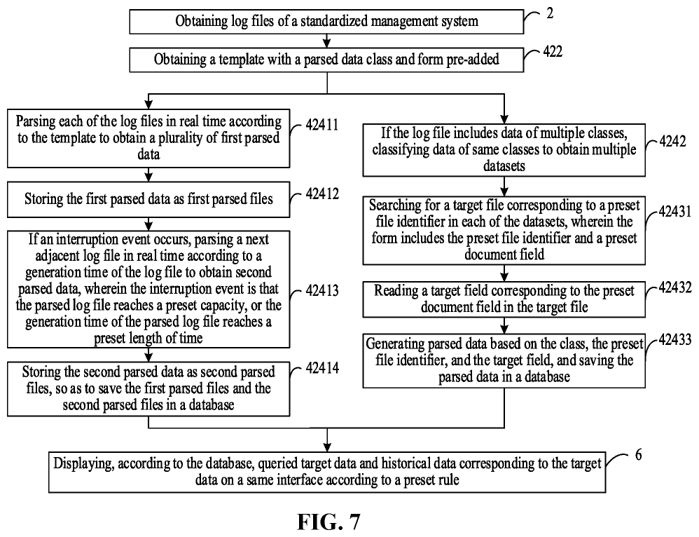

Further, with reference to FIG. 7, in an embodiment of this application, the parsing each of the log files in real time according to the template includes the following operations.

At S42411, each of the log files is parsed in real time according to the template to obtain a plurality of first parsed data.

At S42412, the first parsed data is stored as first parsed files.

At S42413, if an interruption event occurs, a next adjacent log file is parsed in real time according to a generation time of the log file to obtain second parsed data. The interruption event is that the parsed log file reaches a preset capacity, or the generation time of the parsed log file reaches a preset length of time.

At S42414, the second parsed data is stored as second parsed files, so as to save the first parsed files and the second parsed files in the database.

Specifically, with continuing reference to FIG. 7, in order to facilitate saving, querying or copying generated parsed data, after parsing each of the log files in real time according to the template to obtain a plurality of first parsed data, the first parsed data is stored as first parsed files. In the process of parsing each of the log files in real time, due to limit by the size of a file storage space or the parsing time duration, an interruption event can occur. Therefore, if an interruption event occurs, a next adjacent log file is parsed in real time according to a generation time of the log file to obtain second parsed data, the second parsed data is stored as second parsed files, and the first parsed files and the second parsed files are saved in the database. The interruption event is that the parsed log file reaches a preset capacity, or the generation time of the parsed log file reaches a preset length of time.

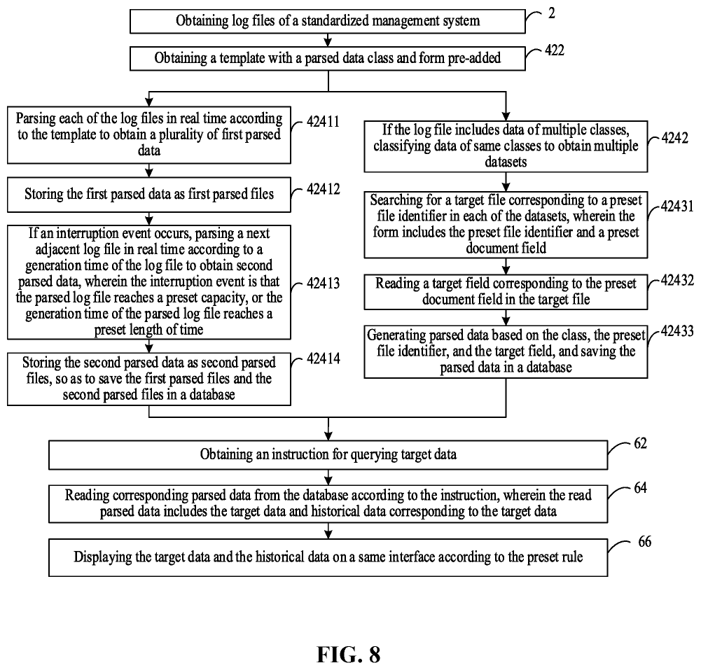

Further, with reference to FIG. 8, in an embodiment of this application, the displaying queried target data and historical data corresponding to the target data on a same interface according to a preset rule and the dataset includes the following operations.

At S62, an instruction for querying the target data is obtained.

At S64, corresponding parsed data is read from the database according to the instruction. The read parsed data includes the target data and the historical data corresponding to the target data.

At S66, the target data and the historical data are displayed on the same interface according to the preset rule.

Specifically, with continuing reference to FIG. 8, in order to make it convenient for a user to query and obtain target data and historical data corresponding to the target data, instruction input prompt information can be generated in a display interface. The instruction that the user can input to query the target data can include at least one of start and end time, class, name, or change identifier of the target data to be queried. For example, an identity authentication method can be used. First, the identity of a user who queries data is authenticated by prompting the user to input a personal employee number and a system login account. After the user logs in to the system successfully, an input prompt dialog box can be generated in the display interface. For example, a data start time input box (Start), a data end time input box (End), a data class input box (Class ID), a data name input box (Class Name), and a change identifier input box (Change Notice) are generated in the display interface, to prompt the user to input corresponding content in corresponding input boxes to select desired target data and historical data corresponding to the target data from the database. As an example, in an embodiment of this application, the change identifier includes at least one of a modification identifier, an addition identifier, or a deletion identifier.

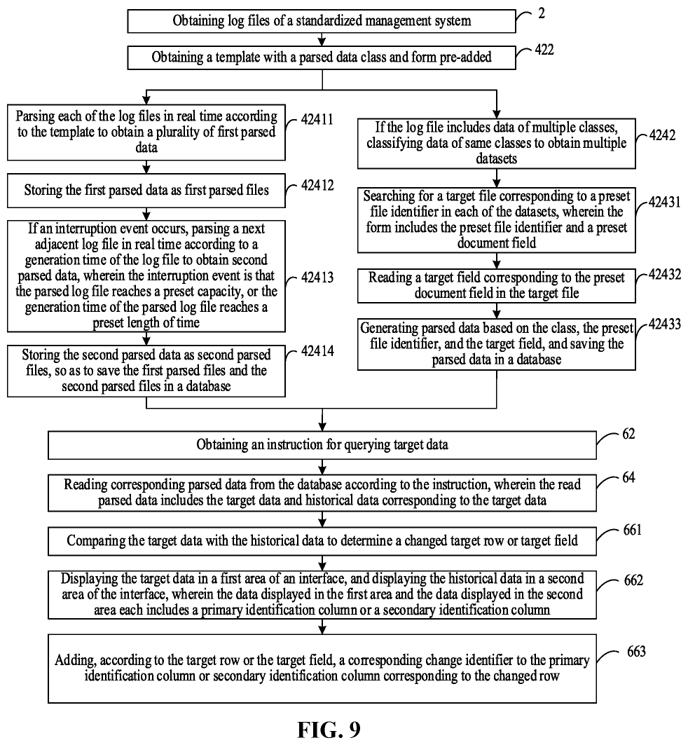

Further, with reference to FIG. 9, in an embodiment of this application, the displaying the target data and the historical data on the same interface according to the preset rule includes the following operations.

At S661, the target data is compared with the historical data to determine a changed target row or target field.

At S662, the target data is displayed in a first area of the interface, and the historical data is displayed in a second area of the interface. The data displayed in the first area and the data displayed in the second area each includes a primary identification column or a secondary identification column.

At S663, according to the target row or the target field, a corresponding change identifier is added to the primary identification column or secondary identification column corresponding to the changed row.

Specifically, with continuing reference to FIG. 9, a user can misoperate current data or historical data in the process of querying data, resulting in data loss or change. In order to save the content of a change to the data during the user's misoperation, the target data is compared with the historical data to determine a changed target row or target field, the target data is displayed in rows and columns in a first area of the interface, and the historical data is displayed in rows and columns in a second area of the interface, so that the user can observe and compare the target data and historical data to discover a data abnormality in a timely manner. A primary identification column or a secondary identification column is configured in each of the data displayed in the first area and the data displayed in the second area. For example, the primary identification column can be used as a main identification field, and the secondary identification column can be used as a minor identification field, so that the user can determine, by comparing the content of the primary identification columns and the secondary identification columns in the target data and the historical data, a row where a data change occurs, and add a corresponding change identifier. For example, if the content of the primary identification columns in the target data and historical data is inconsistent, it is considered that an entire row change occurs, such as row addition or row deletion; if the content of the primary identification columns in the target data and the historical data is the same, and the content of secondary identification columns therein is different, it is considered that a data change occurs to the target row; and if the content of the primary identification columns and the content of the secondary identification columns in the target data and the historical data are the same, it is considered that no data change occurs.

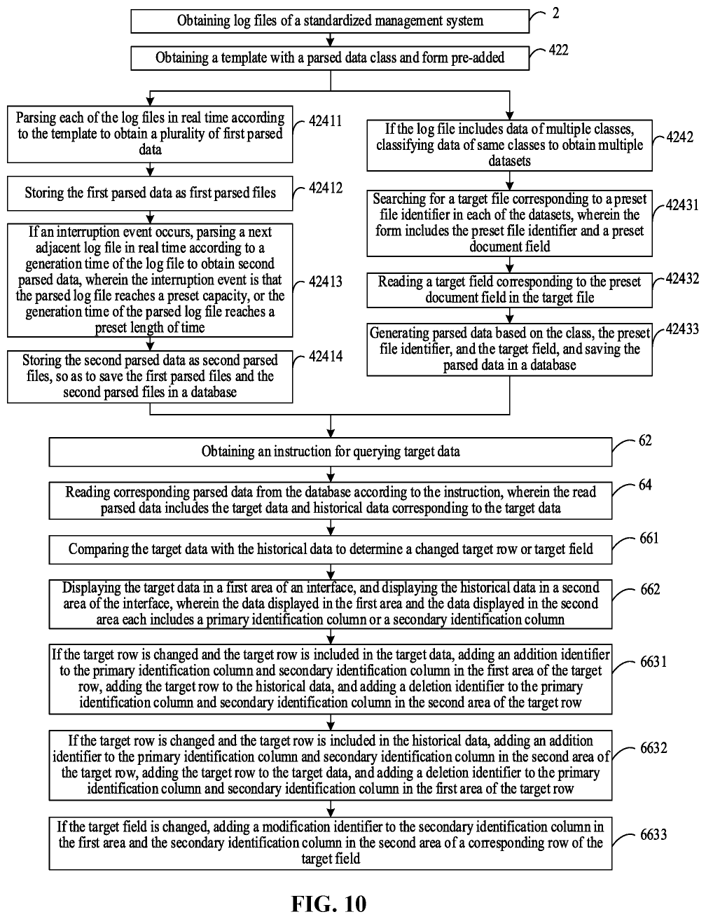

Further, with reference to FIG. 10, in an embodiment of this application, the adding a corresponding change identifier to the primary identification column or secondary identification column corresponding to the changed row according to the target row or the target field includes the following operations.

At S6631, if the target row is changed and the target row is included in the target data, an addition identifier is added to the primary identification column and secondary identification column in the first area of the target row, the target row is added to the historical data, and a deletion identifier is added to the primary identification column and secondary identification column in the second area of the target row;

At S6632, if the target row is changed and the target row is included in the historical data, an addition identifier is added to the primary identification column and secondary identification column in the second area of the target row, the target row is added to the target data, and a deletion identifier is added to the primary identification column and secondary identification column in the first area of the target row.

At S6633, if the target field is changed, a modification identifier is added to the secondary identification column in the first area and the secondary identification column in the second area of a corresponding row of the target field.

Specifically, with continuing reference to FIG. 10, in order to save the content of a user's change to the database, visually display the content of the change, and make it convenient for the user to restore misoperated data, when it is detected that the content of the primary identification columns in the target data and the historical data is inconsistent, it is considered that an entire row change occurs; and if the target row is changed and the target row is included in the target data, an addition identifier is added to the primary identification column and secondary identification column in the first area of the target row, the target row is added to the historical data, and a deletion identifier is added to the primary identification column and secondary identification column in the second area of the target row. When it is detected that the content of the primary identification columns in the target data and the historical data is inconsistent, it is considered that an entire row change occurs; and when the target row is changed and the target row is included in the historical data, an addition identifier is added to the primary identification column and secondary identification column in the second area of the target row, the target row is added to the target data, and a deletion identifier is added to the primary identification column and secondary identification column in the first area of the target row. When the content of the primary identification columns in the target data and the historical data is the same, and the content of the secondary identification columns therein is different, it is considered that the target row is changed in the target field, a modification identifier is added to the secondary identification column in the first area and the secondary identification column in the second area of a corresponding row of the target field. When the content of the primary identification columns and the content of the secondary identification columns in the target data and the historical data are the same, it is considered that no data change occurs; and the target data is directly displayed in rows and columns in the first area of the interface, and the historical data is directly displayed in rows and columns in the second area of the interface, so that the user can observe and compare the target data and historical data, and visually see a change record related to the target data or historical data.

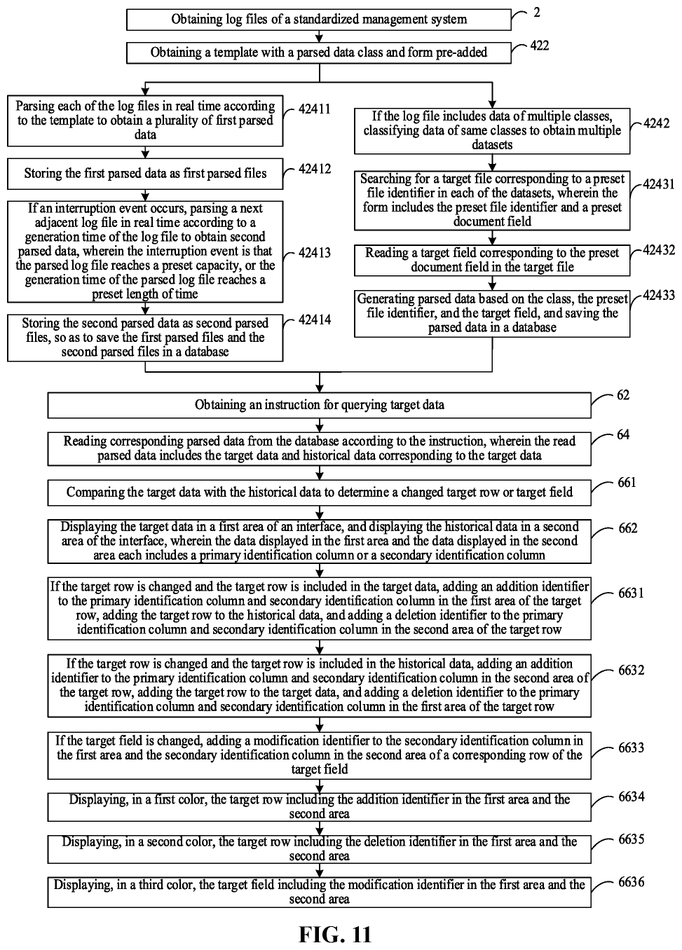

Further, with reference to FIG. 11, in an embodiment of this application, the displaying the target data and the historical data on the same interface according to the preset rule further includes the following operations.

At S6634, the target row including the addition identifier in the first area and the second area is displayed in a first color.

At S6635, the target row including the deletion identifier in the first area and the second area is displayed in a second color.

At S6636, the target field including the modification identifier in the first area and the second area is displayed in a third color.

Specifically, with continuing reference to FIG. 11, the target row including the addition identifier in the first area and the second area is displayed in a first color, the target row including the deletion identifier in the first area and the second area is displayed in a second color, and the target field including the modification identifier in the first area and the second area is displayed in a third color, for example, the target row including the addition identifier in the first area and the second area can be displayed in green, the target row including the deletion identifier in the first area and the second area can be displayed in gray, and the target field including the modification identifier in the first area and the second area can be displayed in red, so that a use can visually see a change record related to the target data or historical data.

As an example, in an embodiment of this application, the SM is a system for monitoring parameter setting data in a semiconductor manufacturing process.

It should be understood that although the various steps in the flowcharts of FIGS. 2-11 are displayed in sequence as indicated by the arrows, these steps are not necessarily executed in sequence as indicated by the arrows. Unless there is a clear description herein, the execution of these steps is not strictly restricted in sequence, and these steps can be executed in other sequences. Moreover, although at least some of the steps in FIGS. 2-11 can include multiple sub-steps or multiple stages, these sub-steps or stages are not necessarily executed at the same time, but can be executed at different times. These sub-steps or stages are not necessarily executed in sequence, but can be executed by turns or alternately together with other steps or at least some of sub-steps or stages of other steps.

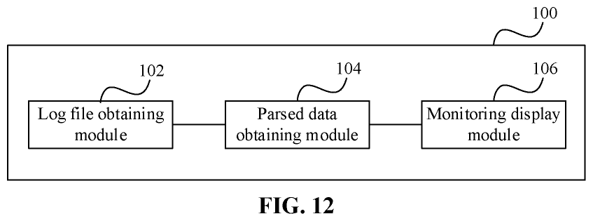

Further, with reference to FIG. 12, in an embodiment of this application, a data monitoring apparatus 100 for a SM system is provided, including a log file obtaining module 102, a parsed data obtaining module 104, and a monitoring display module 106. The log file obtaining module 102 is configured to obtain log files of a SM system. The parsed data obtaining module 104 is configured to parse the log files to obtain parsed data, and save the parsed data in a database. The monitoring display module 106 is configured to display, according to the database, queried target data and historical data corresponding to the target data on a same interface according to a preset rule.

Specifically, with continuing reference to FIG. 12, the log file obtaining module 102 obtains log files of a SM system, and the parsed data obtaining module 104 parses the log files to obtain parsed data, and save the parsed data in a database, so that the monitoring display module 106 can display queried target data and historical data corresponding to the target data on a same interface according to a preset rule and the database. Thus, it is convenient for a user to compare the target data and the historical data corresponding to the target data in the same interface, discover a data change timely and restore the data, thereby preventing the user from changing saved data due to misoperation. It is also convenient for the user to analyze the historical data to discover production abnormality information or failure information timely, and take a countermeasure timely, so as to avoid an unnecessary loss.

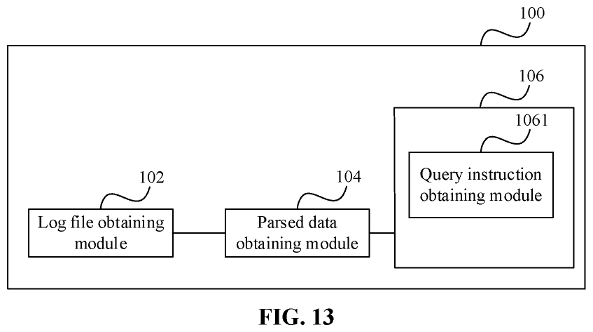

Further, with reference to FIG. 13, in an embodiment of this application, the monitoring display module 106 includes a query instruction obtaining module 1061. The query instruction obtaining module 1061 is configured to obtain an instruction for querying the target data. The instruction includes at least one of start and end time, class, name, or change identifier of the target data to be queried. The change identifier includes at least one of a modification identifier, an addition identifier, or a deletion identifier. According to this embodiment, it is convenient for a user to input an instruction for querying the target data by a query instruction obtaining module, and after inputting to the query instruction obtaining module the instruction including at least one of start and end time, class, name, or change identifier of the target data to be queried, display queried target data and historical data corresponding to the target data on a same interface. The change identifier includes at least one of a modification identifier, an addition identifier, or a deletion identifier. It is convenient for the user to compare the target data and the historical data corresponding to the target data in the same interface, and discover a data change timely and restore the data, thereby preventing the user from changing saved data due to misoperation. It is also convenient for the user to analyze the historical data to discover production abnormality information or failure information timely, and take a countermeasure timely, so as to avoid an unnecessary loss.

For specific definitions on the data monitoring apparatus for a SM, reference can be made to the above definitions on the data monitoring method for a SM, and details are not described here again.

The modules in the foregoing data monitoring apparatus for a SM can be implemented in whole or in part by software, hardware, or a combination thereof. The foregoing modules can be embedded in or independent of a processor in a computer device in the form of hardware, or can be stored in a memory of the computer device in the form of software, so as to be invoked by the processor to execute operations corresponding to the foregoing modules.

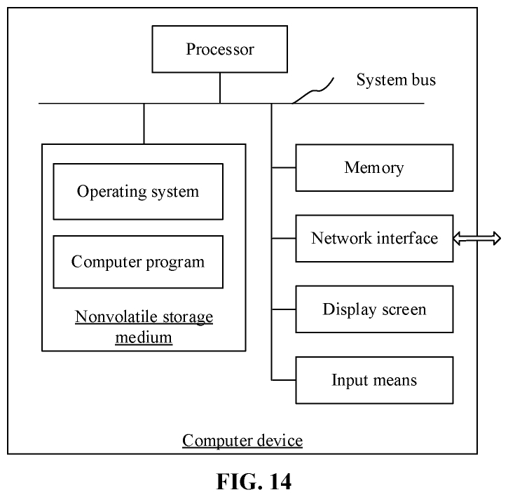

Further, with reference to FIG. 14, in an embodiment of this application, a computer device is provided, including a memory and a processor. The memory stores a computer program which can be run on the processor, and steps of the method in any of the embodiments in this application are implemented when the processor executes the program.

Further, in an embodiment of this application, a computer-readable storage medium is provided with a computer program stored thereon. Steps of the method in any of the embodiments in this application are implemented when the computer program is executed by a processor.

In the computer device or the computer-readable storage medium in the foregoing embodiment, by obtaining log files of a SM, parsing the log files to obtain parsed data, saving the parsed data in a database, and displaying, according to the database, queried target data and historical data corresponding to the target data on a same interface according to a preset rule, it is convenient for a user to compare the target data and the historical data corresponding to the target data in the same interface, discover a data change timely and restore the data, thereby preventing the user from changing saved data due to misoperation. It is also convenient for the user to analyze the historical data to discover production abnormality information or failure information timely, and take a countermeasure timely, so as to avoid an unnecessary loss.

Those skilled in the art can understand that: all or some of the processes in the methods in the foregoing embodiments can be implemented by instructing relevant hardware by a computer program, the computer program can be stored in a non-volatile computer-readable storage medium, and when the computer program is executed, processes including the foregoing embodiments of the methods are performed. Any reference to the memory, storage, database or other media used in the embodiments provided in this application can include a non-volatile and/or volatile memory. The non-volatile memory can include a Read Only Memory (ROM), a Programmable ROM (PROM), an Erasable Programmable ROM (EPROM), an Electrically-Erasable Programmable ROM (EEPROM), or a flash memory. The volatile memory can include a Random-Access Memory (RAM) or an external cache memory. As an illustration but not a limitation, the RAM is available in many forms, such as a static RAM (SRAM), a dynamic RAM (DRAM), a synchronous DRAM (SDRAM), a double data rate SDRAM (DDRSDRAM), an enhanced SDRAM (ESDRAM), a SynchLink DRAM (SLDRAM), a Rambus Direct RAM (RDRAM), a Direct Rambus Dynamic RAM (DRDRAM), and a Rambus Dynamic RAM (RDRAM).

The technical features in the foregoing embodiments can be combined arbitrarily. For brevity of description, not all possible combinations of the various technical features in the foregoing embodiments are described. However, as long as there is no contradiction in the combination of these technical features, it should be regarded as falling within the scope described in this description.

The foregoing embodiments only express several implementations of this application, which are described relatively specifically and in detail, but should not be understood as limitations to the scope of the patent application. It should be noted that many modifications and improvements can be made by those skilled in the art without departing from the concept of this application, and those modifications and improvements should also be regarded as falling within the scope of protection of this application. Therefore, the scope of protection of this patent application should be determined by the scope of protection of the appended claims.

What is claimed is:

1. A data monitoring method for a standardized management system, comprising:
obtaining log files of the standardized management system;
parsing the log files to obtain parsed data, and saving the parsed data in a database; and
displaying queried target data and historical data corresponding to the target data on a same interface based on the database according to a preset rule.

2. The method of claim 1, wherein the parsing the log files to obtain parsed data comprises: parsing each of the log files in real time to obtain the parsed data.

3. The method of claim 2, wherein the parsing each of the log files in real time comprises:
obtaining a template with pre-added classes and forms of the parsed data; and
parsing each of the log files in real time according to the template to obtain the parsed data.

4. The method of claim 3, wherein the parsing each of the log files in real time according to the template comprises:
responsive to that the log file comprises data of multiple classes, classifying data of the same classes to obtain multiple datasets; and
parsing each of the datasets comprising data of the same class by a loop according to the template.

5. The method of claim 4, wherein the forms comprise a preset file identifier and a preset document field; and the parsing each of the datasets comprising data of the same class by a loop according to the template comprises:
searching for a target file corresponding to a preset file identifier in the dataset;
reading a target field corresponding to a preset document field in the target file; and
generating the parsed data based on the class, the preset file identifier, and the target field.

6. The method of claim 3, wherein the parsing each of the log files in real time according to the template further comprises:
parsing each of the log files in real time according to the template to obtain a plurality of first parsed data;
storing each of the first parsed data as first parsed files;
responsive to an interruption event occurs, parsing a next adjacent log file in real time according to a generation time of the log file to obtain second parsed data, wherein the interruption event is that the parsed log file reaches a preset capacity, or the generation time of the parsed log file reaches a preset length of time; and
storing the second parsed data as second parsed files, so as to save the first parsed files and the second parsed files in the database.

7. The method of claim 1, wherein, according to the database, displaying queried target data and historical data corresponding to the target data on a same interface according to a preset rule comprises:
obtaining an instruction for querying the target data;
reading corresponding parsed data from the database according to the instruction, wherein the read parsed data comprises the target data and the historical data corresponding to the target data; and
displaying the target data and the historical data on the same interface according to the preset rule.

8. The method of claim 7, wherein the instruction comprises at least one of start and end time, class, name, and change identifier of the queried target data; and
the change identifier comprises at least one of a modification identifier, an addition identifier, or a deletion identifier.

9. The method of claim 8, wherein the displaying the target data and the historical data on the same interface according to the preset rule comprises:
comparing the target data with the historical data to determine a changed target row or target field;
displaying the target data in a first area of the interface, and displaying the historical data in a second area of the interface, wherein the data displayed in the first area and the data displayed in the second area both comprises a primary identification column or a secondary identification column; and
adding a corresponding change identifier to the primary identification column or secondary identification column corresponding to the changed row, according to the target row or the target field.

10. The method of claim 9, wherein the adding a corresponding change identifier to the primary identification column or secondary identification column corresponding to the changed row, according to the target row or the target field, comprises:
responsive to that the target row is changed and the target row is comprised in the target data, adding an addition identifier to the primary identification column and secondary identification column in the first area of the target row, adding the target row to the historical data, and adding a deletion identifier to the primary identification column and secondary identification column in the second area of the target row;
responsive to that the target row is changed and the target row is comprised in the historical data, adding an addition identifier to the primary identification column and secondary identification column in the second area of the target row, adding the target row to the target data, and adding a deletion identifier to the primary identification column and secondary identification column in the first area of the target row; and
responsive to that the target field is changed, adding a modification identifier to the secondary identification column in the first area and the secondary identification column in the second area of a corresponding row of the target field.

11. The method of claim 10, wherein the displaying the target data and the historical data on the same interface according to the preset rule further comprises:
displaying the target row comprising the addition identifier in the first area and the second area in a first color.

12. The method of claim 10, wherein the displaying the target data and the historical data on the same interface according to the preset rule further comprises:
displaying the target row comprising the deletion identifier in the first area and the second area in a second color.

13. The method of claim 10, wherein the displaying the target data and the historical data on the same interface according to the preset rule further comprises:
displaying the target field comprising the modification identifier in the first area and the second area in a third color.

14. The method of claim 1, wherein the standardized management system is a system for monitoring parameter setting data in a semiconductor manufacturing process.

15. A data monitoring apparatus for a standardized management system, comprising:
a log file obtaining module, being configured to obtain log files of a standardized management system;
a parsed data obtaining module, being configured to parse the log files to obtain parsed data, and save the parsed data in a database; and
a monitoring display module, being configured to display the queried target data and historical data corresponding to the target data on a same interface according to a preset rule and the database.

16. The apparatus of claim 15, wherein the monitoring display module comprises:
a query instruction obtaining module, configured to obtain an instruction for querying the target data, wherein the instruction comprises at least one of start and end time, class, name, or change identifier of the queried target data, and the change identifier comprises at least one of a modification identifier, an addition identifier, and a deletion identifier.

17. A computer device, comprising:
a processor; and
a memory for storing a computer program which can be run on the processor;
wherein the processor is configured to:
obtaining log files of the standardized management system;
parsing the log files to obtain parsed data, and saving the parsed data in a database; and
displaying queried target data and historical data corresponding to the target data on a same interface based on the database according to a preset rule.

18. A non-transitory computer-readable storage medium having a computer program stored thereon that, when executed by a processor, causes to perform a data monitoring method for a standardized management system according to claim 1.
